(19) United States
(12) Patent Application Publication
(10) Pub. No.: US 2015/0070884 A1
(43) Pub. Date: Mar. 12, 2015

(54) MULTIFUNCTIONAL LAMP

(71) Applicant: LAI-FU WU, NEW TAIPEI CITY (TW)

(72) Inventor: LAI-FU WU, NEW TAIPEI CITY (TW)

(21) Appl. No.: 14/024,618

(22) Filed: Sep. 11, 2013

(51) Int. Cl. F21K 99/00; F21V 23/00

(52) U.S. Cl. CPC F21K 9/175; F21V 23/006
USPC 362/221

(57) ABSTRACT

A multifunctional lamp includes a lamp module and an installing plate. The lamp module includes an aluminum extruded base with an installing portion disposed at the front side of the base for installing an electric power control board and an LED lamp panel, and both electric power control board and LED lamp panel are covered by a lamp cover to achieve a waterproof effect. The base backside has an embedding slot for embedding the installing plate, and the installing plate has a screw hole. The base backside also has a magnetic portion or a through hole and a Velcro tape, such that the lamp can be fixed by a screwing, hanging, magnetic attraction or tying method. In addition, both ends of the lamp module have a waterproof DC input interface provided for a serial connection for an extension to fit the use at different places.

### BACKGROUND OF THE INVENTION

1. Field of the Invention

The present invention relates to the technical field of illumination lamp modules, and more particularly to a waterproof multifunctional lamp that is combined with an installation plate and can be used in various places by screwing, hanging, magnetic attraction or tying methods.

2. Description of the Related Art

In recent years, light emitting diode (LED) has the advantages of low voltage, low power consumption and long life over conventional light sources, and thus various illumination lamp modules applying LEDs are introduced into the market. Since the LED has a significant advantage in power saving, therefore it is used extensively in the field of illumination, and its practicality becomes very important.

At present, the common lamp modules adopting the LED as an illumination source include road lamps, indoor illumination lamp modules, table lamps or even flashlights. LED emits light by using a power driver chip (also known as LED chip) with regulated voltage and current, so that there are issues of increasing the temperature and generating heat during the light emission. In particular, some high-power LED chips generate high heat, so that the chip of the illumination lamp module or electric power control board will overheat, and the life of the lamp will be shortened significantly. Therefore, solving heat dissipation issue is the first priority in most of the LED lamp modules. In addition, various types of LED lamp modules adopt different fixing methods or different designs of fixing bases according to their application. Traditional fixing base is generally used in the illumination lamp module, so that the conventional lamp module can be used at a fixed point. However, the illumination area of the conventional illumination lamp is very limited; thus, the conventional illumination lamp module has a narrow scope of applicability and requires improvements.

In view of the aforementioned problems of the conventional illumination lamp, the inventor of the present invention designed and developed a waterproof multifunctional lamp that can be fixed by screwing, magnetic attraction, hanging or typing methods, and the multifunctional lamp has a design with an LED lamp panel and an electric power control board integrated or detached with respect to each other, so as to improve the practical application of the lamp.

### SUMMARY OF THE INVENTION

Therefore, it is a primary objective of the present invention to overcome the problems of the prior art by providing a multifunctional lamp, comprising a lamp module with an embedding slot formed at the backside of the lamp module for embedding and fixing an installing plate, wherein the installing plate comes with a design of a screw hole, a magnetic portion, a through hole and a Velcro tape for fixing the lamp module by a screwing, magnetic attraction, hanging or tying method, so as to improve the stability of fixing the lamp module and extend the scope of the applicability of the lamp.

Another objective of the present invention is to provide a multifunctional lamp, wherein an LED lamp panel and an electric power control board inside the lamp module can be integrated or detached to improve the flexibility of manufacture and reduce the waste of material.

To achieve the aforementioned objectives, the present invention provides a multifunctional lamp, comprising:

a lamp module, including:

a base, being a long-strip structure, and having an installing portion disposed on a side of the base, an embedding slot formed on the other side of the base, a latch slot formed separately on both outer sides of the base, and an opening formed at the embedding slot and disposed opposite to both ends of the base;

an electric power control board, installed to the installing portion, and electrically coupled to an external DC power supply, for receiving a DC power of 12V-36V, and outputting the required DC power after the DC power is processed by an over-voltage protection, an over-current protection and a DC power conversion;

at least one LED lamp panel, installed to the installing portion, and electrically coupled to the electric power control board, and having a plurality of LED chips electrically coupled to the LED lamp panel, so that the DC power of the electric power control board can be used to drive the LED lamp panel to emit light; and

a lamp cover, mounted on two side edges of the electric power control board and the LED lamp panel, for covering the electric power control board and the LED lamp panel therein to achieve a waterproof effect; and

at least one installing plate, installed on the backside of the base, and having a screw hole formed at the center of the installing plate for installing a hanging hook or screwed and fixed onto a surface, and at least one secondary fixing portion disposed on a side of the screw hole, and the secondary fixing portion being selected from the collection of a magnet, a Velcro tape and a combination thereof, and attracted or attached onto a metal or magnetic surface, or tied onto a column.

Wherein, the installing plate can be fixed by the following two methods: (1) The installing plate installing plate is passed into the embedding slot through the opening, and the fixation of the installing plate is achieved by clamping the two side edges of the installing plate into the embedding slot. (2) The two side edges of the installing plate have a pair of inwardly bent first latch portions corresponding to a pair of clamping boards respectively, so that the pair of first latch portions are latched into the latch slots to cover and fix the installing plate to the backside of the lamp module.

Wherein, the electric power control board includes a waterproof DC input interface, a first DC output interface, a second DC output interface, an over-voltage and over-current protection module and a DC power conversion module, and the waterproof DC input interface is electrically coupled to the over-voltage and over-current protection module, and the first DC output interface is installed between the waterproof DC input interface and the over-voltage and over-current protection module, and the over-voltage and over-current protection module is electrically coupled to the DC power conversion module, and the DC power conversion module is electrically coupled to the second DC output interface, and the second DC output interface outputs electric power to the LED lamp panel, and the second DC output interface is electrically coupled to a waterproof DC output interface and covered by a casing.

Wherein, the electric power control board and the LED lamp panel are integrated on a same circuit board to lower the manufacturing cost.

In a preferred embodiment of the present invention, the multifunctional lamp further comprises a flap coupled to a side of the installing plate and installed on the backside of the lamp module, and a setting angle is defined between the flap and the installing plate, and the setting angle falls within a range of 10 degrees to 90 degrees, and this angle determines the illuminating angle of the multifunctional lamp after the lamp is fixed. The flap can be fixed by the following two methods: (1) The flap is passed into the embedding slot through the opening and fixed by clamping the flap into the embedding slot. (2) This method is similar to the method of the previous preferred embodiment, and the two side edges of the installing plate have a pair of inwardly bent second latch portions corresponding to a pair of clamping boards respectively, so that the pair of second latch portions are latched into the latch slots to cover and fix the installing plate to the backside of the lamp module.

In a preferred embodiment of the present invention, the multifunctional lamp further comprises an adjusting pivot installed at a joint position of the flap and the installing plate for adjusting the setting angle between the flap and the installing plate and making the angle adjustment more conveniently.

The aforementioned and other objectives, technical characteristics and advantages of the present invention will become apparent with the detailed description of preferred embodiments and the illustration of related drawings as follows.

### BRIEF DESCRIPTION OF THE DRAWINGS

FIG. 1 is an exploded view of a first preferred embodiment of the present invention;

FIG. 2 is a sectional view of the first preferred embodiment of the present invention;

FIG. 3 is a sectional view of another implementation mode of the first preferred embodiment of the present invention;

FIG. 4 is a first schematic view of the first preferred embodiment of the present invention at a fixed mode;

FIG. 5 is a second schematic view of the first preferred embodiment of the present invention at a fixed mode;

FIG. 6 is a third schematic view of the first preferred embodiment of the present invention at a fixed mode;

FIG. 7 is a fourth schematic view of the first preferred embodiment of the present invention at a fixed mode;

FIG. 8 is a schematic view of a second preferred embodiment of the present invention; and

FIG. 9 is a schematic view of a third preferred embodiment of the present invention.

### DETAILED DESCRIPTION OF THE PREFERRED EMBODIMENTS

### First Embodiment

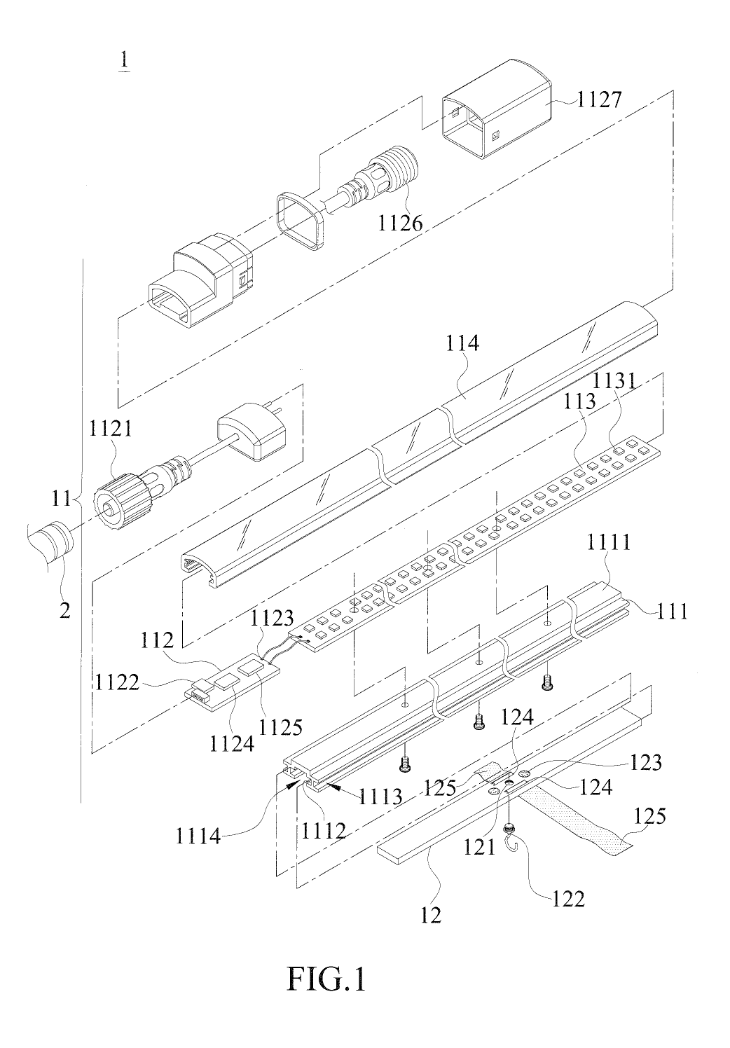

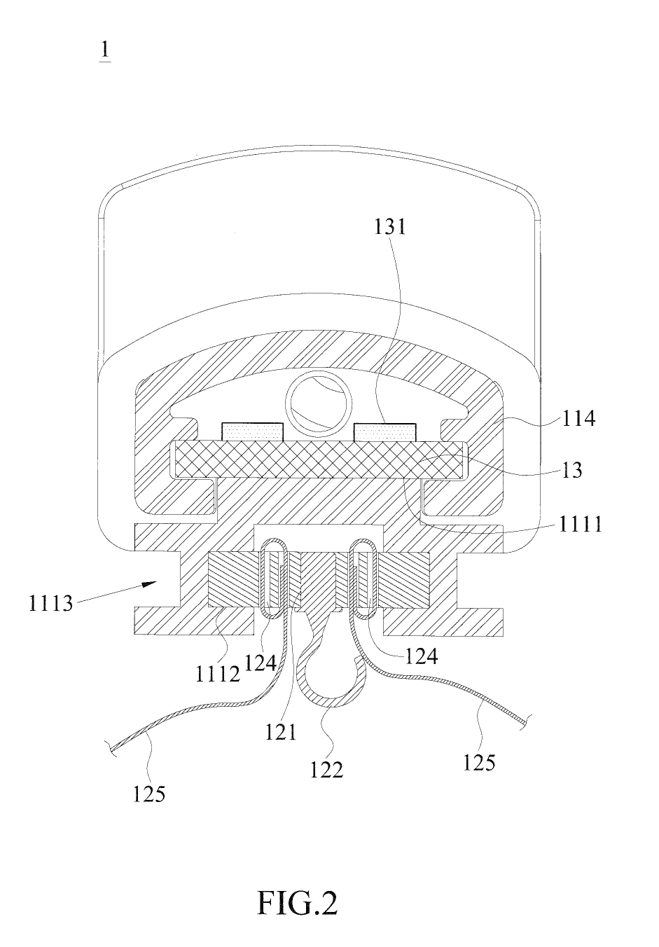

With reference to FIGS. 1-3 and 4-7 for an exploded view and sectional views of a multifunctional lamp in accordance with the first preferred embodiment of the present invention and schematic views of different fixed modes of the multifunctional lamp in accordance with the first preferred embodiment of the present invention respectively. The multifunctional lamp 1 comprises a lamp module 11 and an installing plate 12.

The lamp module 11 comprises a base 111 which is an aluminum extruded, plastic or ceramic long-strip structure, wherein a planar installing portion 1111 is provided on the top of the base 11, and an embedding slot 1112 is formed at the bottom of the base 11, and both outer sides of the base 111 have a latch slot 1113, and an opening 1114 is formed separately at both ends of the embedding slot 1112. An electric power control board 112 is provided at the installing portion 1113. The electric power control board 112 is provided with a waterproof DC input interface 1121, a first DC output interface 1122, a second DC output interface 1123, an over-voltage and over-current protection module 1124, and a DC power conversion module 1125; wherein the waterproof DC input interface 1121 is electrically coupled to the over-voltage and over-current protection module 1124, and the first DC output interface 1122 is installed between the waterproof DC input interface 1121 and the over-voltage and over-current protection module 1124. The over-voltage and over-current protection module 1124 is electrically coupled to the DC power conversion module 1125, and the DC power conversion module 1125 is electrically coupled to the second DC output interface 1123 and electrically coupled to an external DC power supply 2 for receiving a DC power of 12V-36V. The DC power is processed by an over-voltage protection, an over-current protection and a DC power conversion before outputting a required 5VDC power. The lamp module 11 further comprises an LED lamp panel 113 having a plurality of LED chips 1131 installed thereon and electrically coupled to the LED lamp panel 113; and the LED lamp panel 113 being disposed at the installing portion 1113 for electrically coupling the electric power control board 112, and the second DC output interface 1123 outputs a 5V of DC power to the LED lamp panel 113 to drive the LED lamp panel 113 to emit light. In the present invention, the life of the electric power control board 112 being shorter than the life of the LED lamp panel 113 is taken into consideration, so that the electric power control board 112 and the LED lamp panel 113 come with a separate design. To lower the manufacturing cost, the electric power control board 112 and the LED lamp panel 113 can be integrated onto the same circuit board, or plural LED lamp panels 113 are connected in series to extend the length of use. And the second DC output interface 1123 is electrically coupled to a waterproof DC output interface 1126, so that the second DC output interface 1123 is normally covered by a casing 1127 to achieve the waterproof and dustproof effects. The lamp module 11 may comprise a lamp cover 114 with two side edges embedded into the latch slot 1113 for covering the electric power control board 112 and the LED lamp panel 113 therein, so as to achieve the waterproof and dustproof effects.

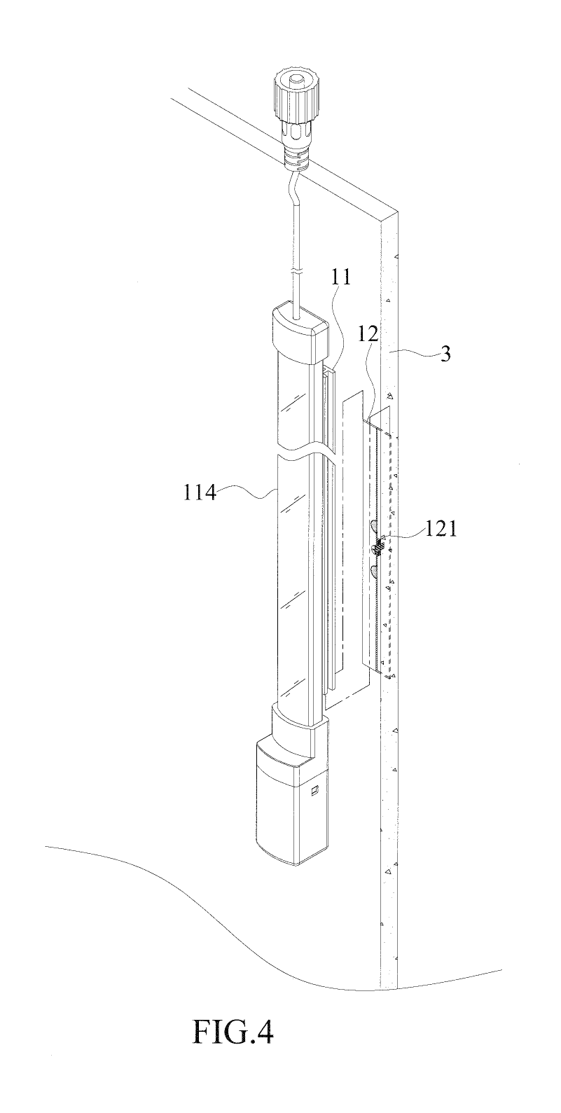

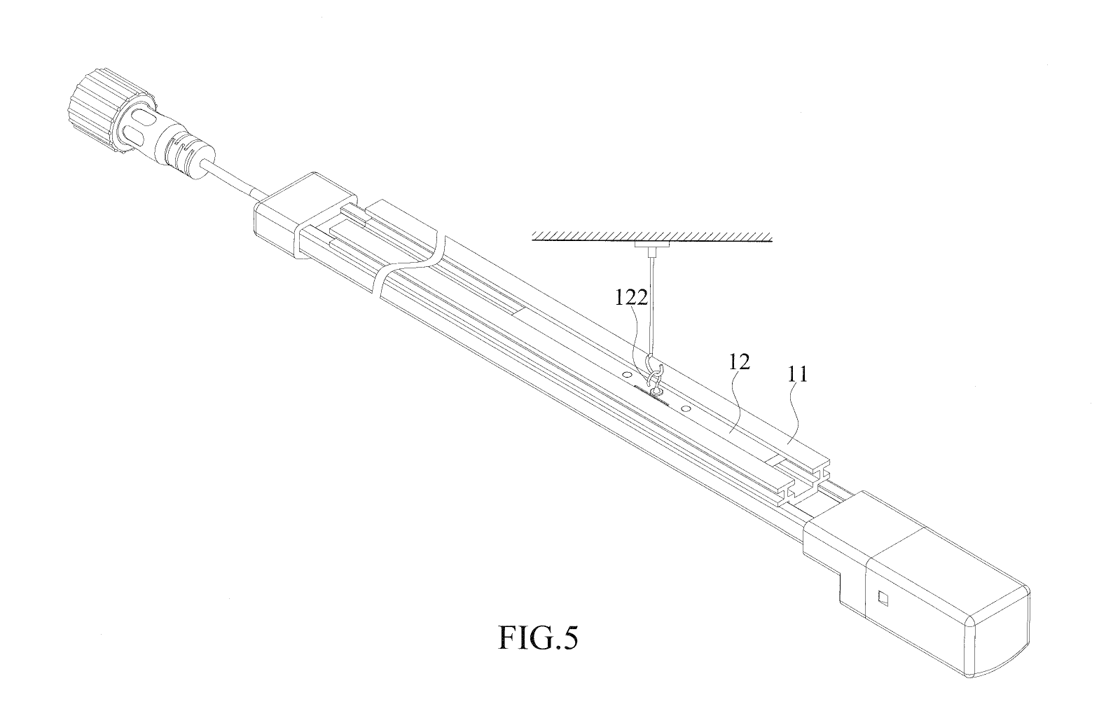

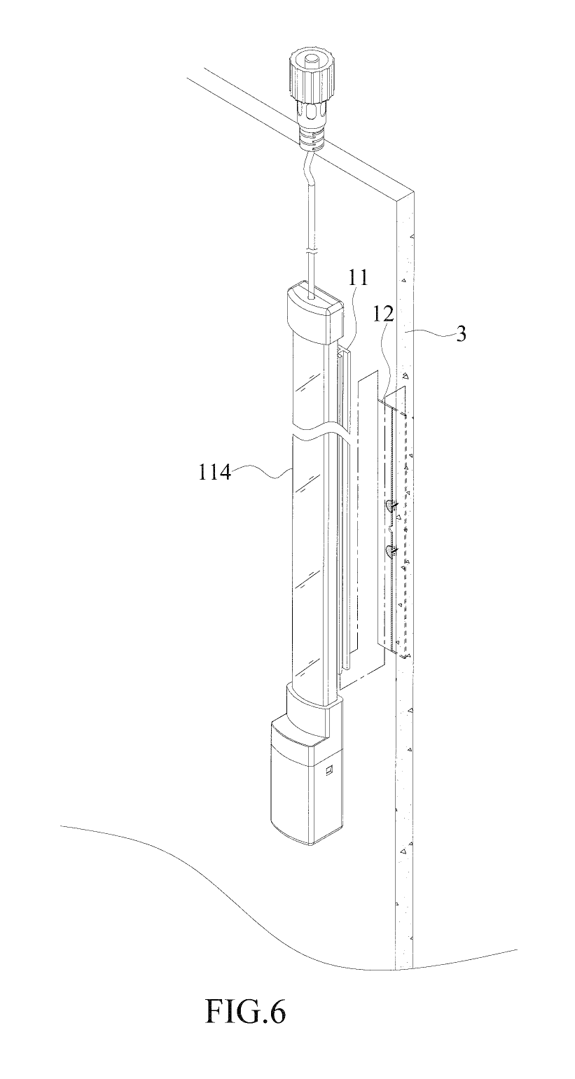

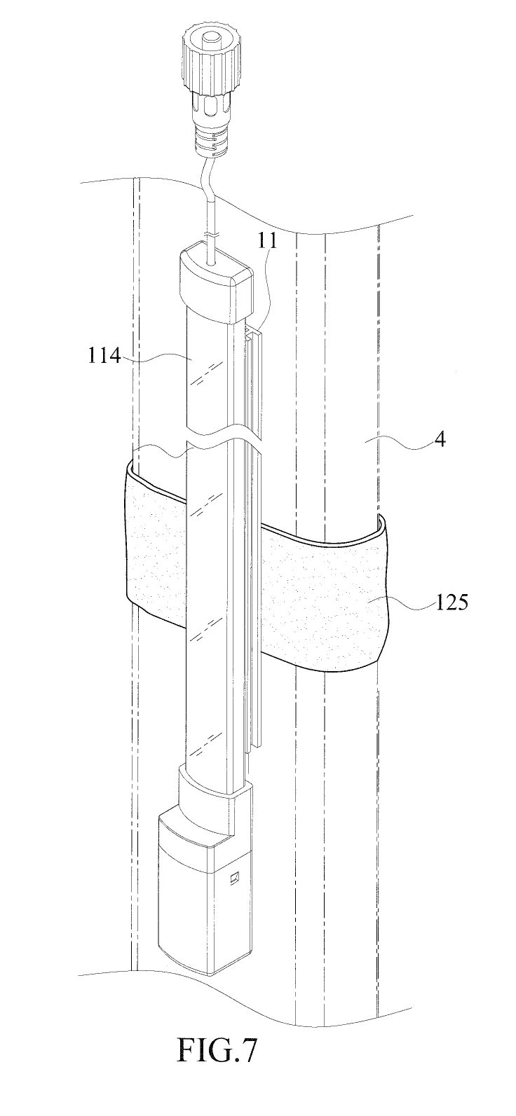

The installing plate 12 is passed into the embedding slot 1112 through the opening 1114 and the two side edges of the installing plate 12 are clamped so as to be fixed in the embedding slot 1112. In FIGS. 4 and 5, a screw hole 121 is formed at the center of the installing plate 12 and screwed directly onto a surface 3 or a hanging hook 122 is installed for hanging the lamp on any protruding object. In FIG. 6, the two sides of the screw hole 121 have a magnetic portion 123 attracted or attached onto a metal or magnetic material surface 3. In FIG. 7, both sides of the screw hole 121 and the magnetic portions 123 have a through hole 124 for passing a Velcro tape 125 (one male and one female) in order to fix lamp onto a column 4 by an adhering or tying method.

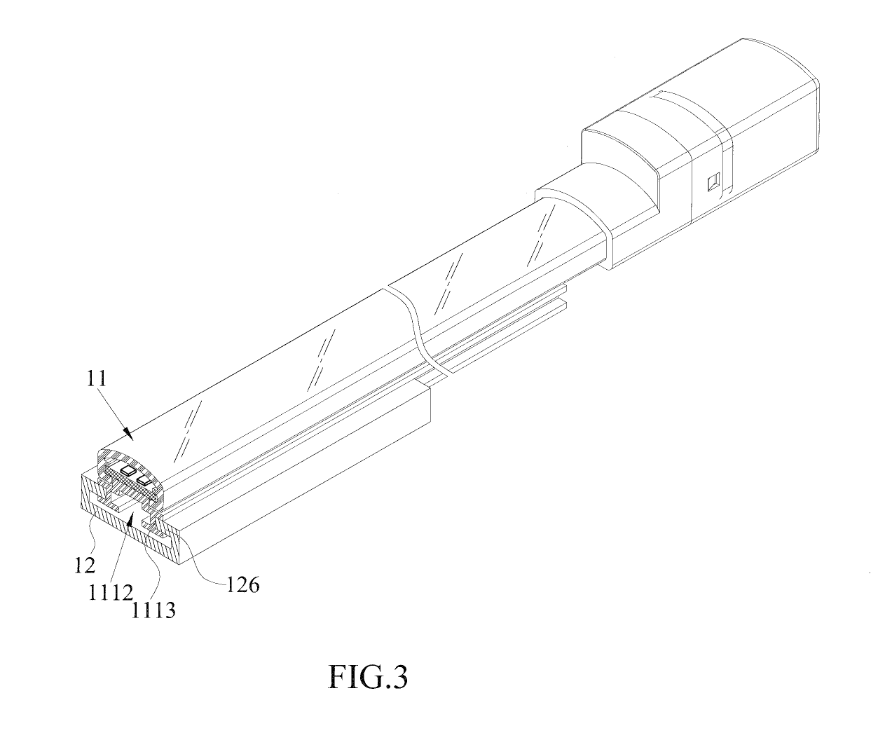

In FIG. 3, the two side edges of the installing plate 12 have an inwardly bent first latch portion 126 corresponding to the latch slot 1113, such that the pair of first latch portions 123 can be latched into the latch slots 1113 respectively to cover and fix the installing plate 12 to the backside of the lamp module 11.

### Second Embodiment

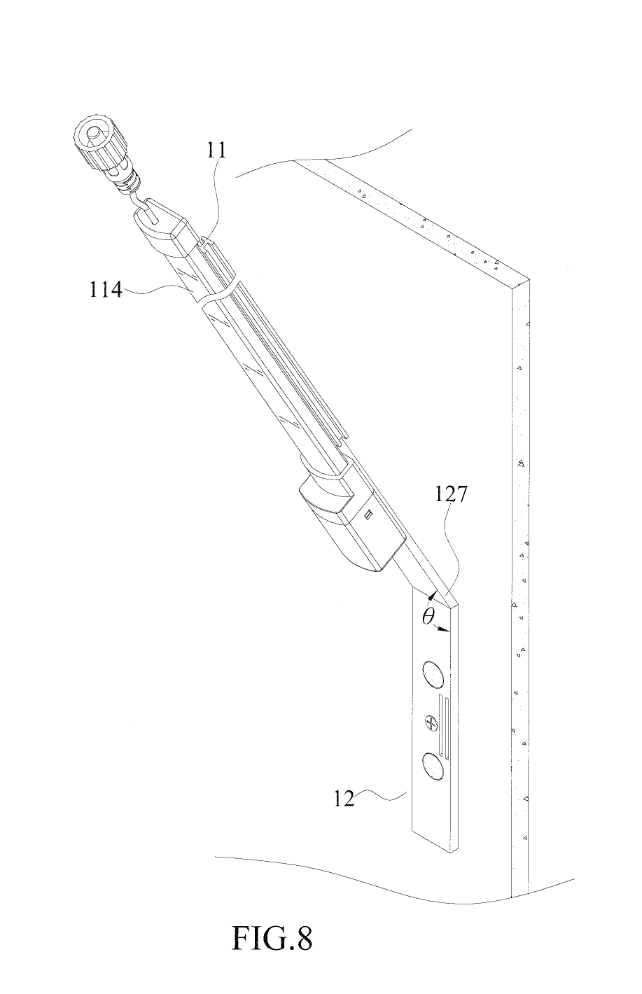

With reference to FIG. 8 for a schematic view of the second preferred embodiment of the present invention, the major difference between the second preferred embodiment and the first preferred embodiment of the present invention resides on that the second preferred embodiment has a flap 127 coupled to a side of the installing plate 12, and a setting angle θ is defined between the flap 127 and the installing plate 12, wherein the setting angle θ falls within a range from 10 degrees to 90 degrees. In FIG. 8, the setting angle θ is approximately equal to 30 degrees. In addition, the installation method of the flap 127 is the same as that of the previous preferred embodiment, and the flap 127 can be installed onto the backside of the lamp module 11 by an embedding or covering method.

### Third Embodiment

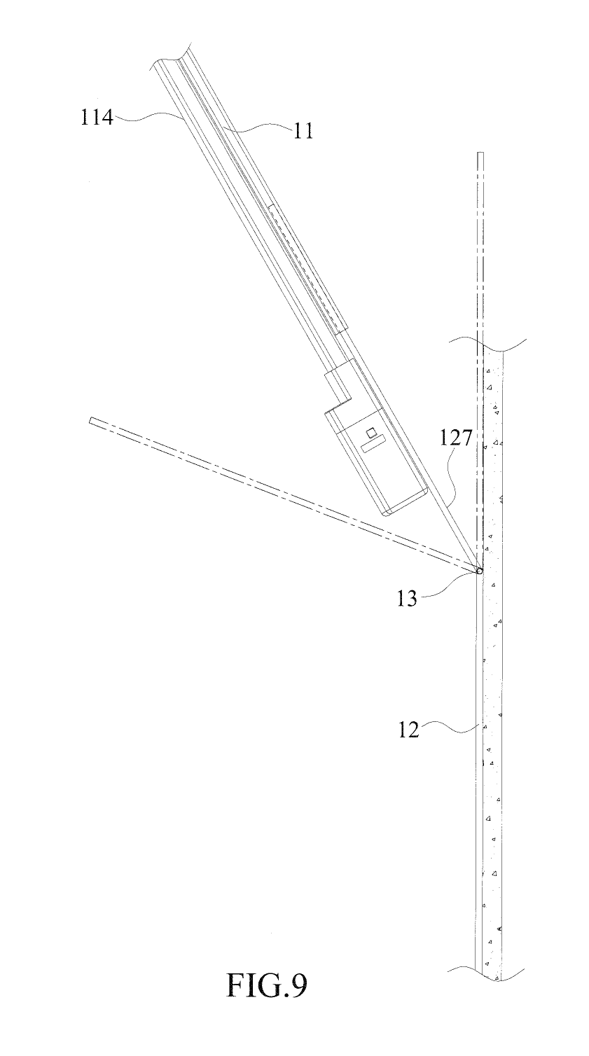

With reference to FIG. 9 for a schematic view of the third preferred embodiment of the present invention. As shown in the figure, an adjusting pivot 13 is provided at a joint position of the flap 127 and the installing plate 12 and provided for adjusting the setting angle between the flap 127 and the installing plate 12. The installation method is the same as the previous two preferred embodiments. After the multifunctional lamp is installed, the illuminating angle of the lamp can be adjusted more conveniently.

What is claimed is:

1. A multifunctional lamp, comprising:
a lamp module, including:
a base, being a long-strip structure, and having an installing portion disposed on a side of the base, an embedding slot formed on the other side of the base, a latch slot formed on both outer sides of the base respectively, and an opening formed at the embedding slot and disposed opposite to both ends of the base;
an electric power control board, installed to the installing portion, and electrically coupled to an external DC power supply, for receiving a DC power of 12V-36V, and outputting the required DC power after the DC power is processed by an over-voltage protection, an over-current protection and a DC power conversion;
at least one LED lamp panel, installed to the installing portion, and electrically coupled to the electric power control board, the LED lamp panel having a plurality of LED chips electrically coupled to the LED lamp panel, so that the DC power of the electric power control board can be used to drive the LED lamp panel to emit light; and
a lamp cover, mounted on two side edges of the electric power control board and the LED lamp panel, for covering the electric power control board and the LED lamp panel therein to achieve a waterproof effect; and
at least one installing plate, installed on the backside of the base, the installing plate having a screw hole formed at the center for installing a hanging hook or screwed and fixed onto a surface, and at least one secondary fixing portion disposed on a side of the screw hole, and the secondary fixing portion being selected from the collection of a magnet, a Velcro tape and a combination thereof, for attracting or attaching onto a metal or magnetic surface, or tying onto a column.

2. The multifunctional lamp of claim 1, wherein the installing plate is passed into the embedding slot through the opening and the two side edges of the installing plate are clamped so as to be fixed in the embedding slot.

3. The multifunctional lamp of claim 1, wherein the two side edges of the installing plate have a pair of inwardly bent first latch portions corresponding to a pair of clamping boards respectively, so that the installing plate is covered and fixed to the backside of the lamp module through latching the pair of first latch portions with the latch slots.

4. The multifunctional lamp of claim 2, wherein the electric power control board includes a waterproof DC input interface, a first DC output interface, a second DC output interface, an over-voltage and over-current protection module and a DC power conversion module, and the waterproof DC input interface is electrically coupled to the over-voltage and over-current protection module, and the first DC output interface is installed between the waterproof DC input interface and the over-voltage and over-current protection module, and the over-voltage and over-current protection module is electrically coupled to the DC power conversion module, and the DC power conversion module is electrically coupled to the second DC output interface, and the second DC output interface outputs electric power to the LED lamp panel, and the second DC output interface is electrically coupled to a waterproof DC output interface and covered by a casing.

5. The multifunctional lamp of claim 3, wherein the electric power control board includes a waterproof DC input interface, a first DC output interface, a second DC output interface, an over-voltage and over-current protection module and a DC power conversion module, and the waterproof DC input interface is electrically coupled to the over-voltage and over-current protection module, and the first DC output interface is installed between the waterproof DC input interface and the over-voltage and over-current protection module, and the over-voltage and over-current protection module is electrically coupled to the DC power conversion module, and the DC power conversion module is electrically coupled to the second DC output interface, and the second DC output interface outputs electric power to the LED lamp panel, and the second DC output interface is electrically coupled to a waterproof DC output interface and covered by a casing.

6. The multifunctional lamp of claim 4, wherein the electric power control board and the LED lamp panel are integrated on a same circuit board.

7. The multifunctional lamp of claim 5, wherein the electric power control board and the LED lamp panel are integrated on a same circuit board.

8. The multifunctional lamp of claim 1, further comprising a flap, coupled to a side of the installing plate, and installed on the backside of the lamp module, and a setting angle is defined between the flap and the installing plate.

9. The multifunctional lamp of claim 8, wherein the flap is passed into the embedding slot through the opening and two side edges of the flap are clamped so as to be fixed in the embedding slot.

10. The multifunctional lamp of claim 8, wherein the two side edges of the flap have a pair of inwardly bent second latch portions corresponding to a pair of clamping boards respectively, so that the installing plate is covered and fixed to the backside of the lamp module through latching the pair of second latch portions with the latch slots.

11. The multifunctional lamp of claim 8, wherein the setting angle falls within a range from 10 degrees to 90 degrees.

12. The multifunctional lamp of claim 8, further comprising an adjusting pivot installed at a joint position of the flap and the installing plate for adjusting the setting angle between the flap and the installing plate.
